(19) United States
(12) Patent Application Publication
(10) Pub. No.: US 2006/0279506 A1
(43) Pub. Date: Dec. 14, 2006

(54) Apparatus and method of driving liquid crystal display apparatus

(76) Inventor: Nam-Gon Choi, Seoul (KR)

Correspondence Address: CANTOR COLBURN, LLP, 55 GRIFFIN ROAD SOUTH, BLOOMFIELD, CT, 06002, US

(21) Appl. No.: 11/451,673

(22) Filed: Jun. 13, 2006

(30) Foreign Application Priority Data
Jun. 14, 2005 (KR) 10-2005-0050878

(51) Int. Cl. G09G 3/36

(52) U.S. Cl. 345/98

(57) ABSTRACT

An apparatus and method for driving a liquid crystal display apparatus include a receiver for receiving input image data, a data processor for processing output image data output from the receiver, and a memory and a transmitter connected to the data processor. The data processor selects a portion of polarities from the output image data and generates a plurality of polarities of the same number as the portion of the polarities to generate polarity data for one frame. Thus, polarities of pairs of pixels corresponding to inversion units are sequentially inverted, so that arbitrary polarity inversion can be individually performed on the pixels. Therefore, preventing cross line defects that are caused from variation in charging voltages in a conventional two-dot inversion driving scheme that is performed in units of two adjacent pixel rows is possible. Further, reducing flicker caused by polarity inversion in units of one frame is also possible.

This application claims priority to Korean Patent Application No. 2005-0050878, filed on Jun. 14, 2005, and all the benefits accruing therefrom under 35 U.S.C. §119, and the contents of which in its entirety are herein incorporated by reference.

### BACKGROUND OF THE INVENTION

(a) Field of the Invention

The present invention relates to an apparatus and method of driving a liquid crystal display apparatus, and more particularly, to an apparatus and method of driving a liquid crystal display apparatus capable of removing a horizontal line defect.

(b) Description of the Related Art

In general, a liquid crystal display (“LCD”) apparatus includes two panels provided with pixel electrodes and a common electrode, respectively, and a liquid crystal layer that has dielectric anisotropy interposed between the two panels. The pixel electrodes are arrayed in a matrix. The pixel electrodes are connected to switching devices, such as thin film transistors (“TFTs”), to be sequentially applied with a data voltage in units of a pixel row. The common electrode is disposed over the entire surface of the panel and is applied with a common voltage. In terms of circuit theory, the pixel electrode and the common electrode together with the liquid crystal layer interposed therebetween constitute a liquid crystal capacitor. The liquid crystal capacitor together with the switching device becomes a unit of a pixel.

In the liquid crystal display apparatus, voltages are applied to the two electrodes to generate an electric field in the liquid crystal layer. By controlling the electric field strength to adjust transmittance of light passing through the liquid crystal layer, a desired image is obtained. If the electric field is applied to the liquid crystal layer in one direction for a long time, deterioration in image quality may occur. Therefore, there is a need to invert polarities of data voltages with respect to the common voltage in units of frames, pixel rows or pixels.

There are several polarity inversion schemes for the data voltages. In one polarity inversion scheme, adjacent odd-numbered and even-numbered pixel rows are taken as an inversion unit. This polarity inversion scheme is called a 2×1 dot inversion driving scheme (hereinafter, referred to as a two-dot inversion driving scheme). In the two-dot inversion driving scheme, each of the odd-numbered and even-numbered pixel rows in the inversion unit have the same polarities, respectively.

In general, in the pixels located at a lower portion of a screen, there is a resistance-capacitance (“RC”) delay, which is represented as a product of resistance of a data line and parasitic capacitance. Due to the RC delay, there may be a difference between the pixel voltages charged in the pixels located at the odd-numbered and even-numbered pixel rows. Therefore, a difference in luminance of the odd-numbered and even-numbered pixel rows may occur causing a horizontal cross line to appear on the screen. In addition, in a case where a still image is displayed with a specific pattern such as a two-dot pattern on the screen, flicker may occur due to variation in charging voltages caused by a kickback voltage.

### BRIEF SUMMARY OF THE INVENTION

The present invention provides an apparatus and method of driving a liquid crystal display apparatus that prevents cross line defects and flicker.

According to an exemplary embodiment of the present invention, an apparatus for driving a liquid crystal display apparatus having a plurality of pixels arrayed in a matrix includes a receiver for receiving input image data, a data processor for processing output image data that is output from the receiver, and a memory and a transmitter connected to the data processor. The data processor selects a portion of polarities from the output image data, and generates the same number of polarities to generate polarity data for one frame.

In the above exemplary embodiment of the present invention, the data processor may generate a basic matrix based on first and second inversion units including at least one pixel, and it further generates a plurality of matrixes that are equal to the basic matrix to generate the polarity of the one frame.

In addition, the data processor may select polarity data for first and second pixel groups as the first and second inversion units, and each of the first and second pixel groups may include at least two pixels that are adjacent to each other in a row or column direction.

The basic matrix may be generated by repeating the first and second inversion units in the row or column direction at least once.

The first and second pixel groups may be located in the first and second row or in the first and second column. In addition, the first and second inversion units may be located in one row interval or in one column interval.

The memory may store the first and second inversion units or the basic matrix. The basic matrix may be an N×M or an M×N matrix, and N may be a natural number of 4 or more and M may be a natural number of 2 or more.

The data processor may generate the polarity data of the next frame for the first and second inversion units based on the polarity data of the current frame for the first and second inversion units. The polarity data of the next frame may be a bit value obtained by adding 1 to the polarity data of the current frame, and the polarities of the first and second inversion units may repeat in units of at least four frames.

The receiver may output input image data that is input in a low voltage differential signaling (“LVDS”) scheme to the data processor in a transistor-transistor logic (“TTL”) scheme.

The apparatus may further include a data driver for applying data voltages to the pixels, wherein the transmitter outputs the output image data that is output from the data processor to the data processor in a reduced swing differential signaling (“RSDS”) scheme.

According to another exemplary embodiment of the present invention, a method of driving a liquid crystal display apparatus having a plurality of pixels arrayed in matrix is provided. The method includes selecting first and second inversion units, storing the first and second inversion units, generating a basic matrix based on the first and second inversion units, and generating polarity data for the pixels by expanding the matrix.

In the above exemplary embodiment of the present invention, the selecting the first and second inversion units may include selecting the polarity data for first and second pixel groups, each of which includes at least two pixels that are adjacent to each other in a row or column direction. The first and second pixel groups may be located in one row interval or in one column interval.

The generating the basic matrix may include repeating the first and second pixel groups in the row or column direction. The basic matrix may be an N×M or an M×N matrix, and N may be a natural number of 4 or more and M may be a natural number of 2 or more.

The method may further include generating polarity data for the next frame based on the polarity data for the pixels. In addition, the generating the polarity data for the next frame may include generating a basic matrix by sequentially changing polarities of the first and second inversion units, and generating a plurality of matrixes that are equal to the basic matrix to generate the polarity data of the next frame. The first and second inversion units repeat in units of at least four frames.

### BRIEF DESCRIPTION OF THE DRAWINGS

The above and other features and advantages of the present invention will become more apparent by describing in detail exemplary embodiments thereof with reference to the attached drawings, in which:

FIG. 1 is a block diagram showing an exemplary liquid crystal display apparatus according to an exemplary embodiment of the present invention;

FIG. 2 is an equivalent circuit schematic diagram showing an exemplary pixel of the liquid crystal display apparatus according to an exemplary embodiment of the present invention;

FIG. 3 is a schematic block diagram showing a signal controller shown in FIG. 1;

FIG. 4 is a flowchart showing an exemplary method of driving a liquid crystal display apparatus according to an exemplary embodiment of the present invention;

FIG. 5 is shows sampling of an exemplary method of driving a liquid crystal display apparatus according to an exemplary embodiment of the present invention;

FIGS. 6A and 6B are tables showing inversion units and corresponding signs in an exemplary inversion driving scheme according to an exemplary embodiment of the present invention;

FIGS. 6C to 6E shows examples of an exemplary selection of inversion units and basic matrixes according to other exemplary embodiments of the present invention;

FIG. 7 is an example of a principle of an exemplary inversion driving scheme according to an exemplary embodiment of the present invention;

FIGS. 8A to 8D shows examples of a binary polarity pattern of exemplary inversion driving schemes according to other exemplary embodiments of the present invention; and

FIG. 9A to 9D show sign polarity patterns corresponding to the binary polarity pattern of the polarity data of FIGS. 8A to 8D, respectively, in terms of positive and negative polarities.

### DETAILED DESCRIPTION OF THE INVENTION

With reference to the accompanying drawings, the present invention will be described in order for those skilled in the art to be able to implement the invention. As those skilled in the art would realize, the described exemplary embodiments may be modified in various different ways, all without departing from the spirit or scope of the present invention.

In the drawings, thicknesses are enlarged for the purpose of clearly illustrating layers and areas. In addition, like elements are denoted by like reference numerals in the whole specification. If it is mentioned that a layer, a film, an area, or a plate is placed on a different element, it includes a case that the layer, film, area, or plate is placed right on the different element as well as a case that another element is disposed therebetween. On the contrary, if it is mentioned that one element is placed right on another element, it means that no element is disposed therebetween. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

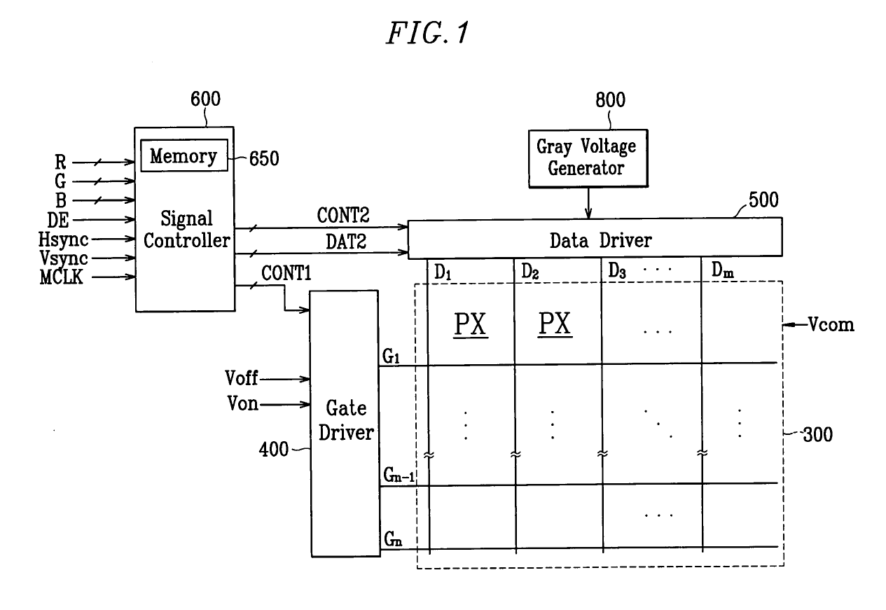

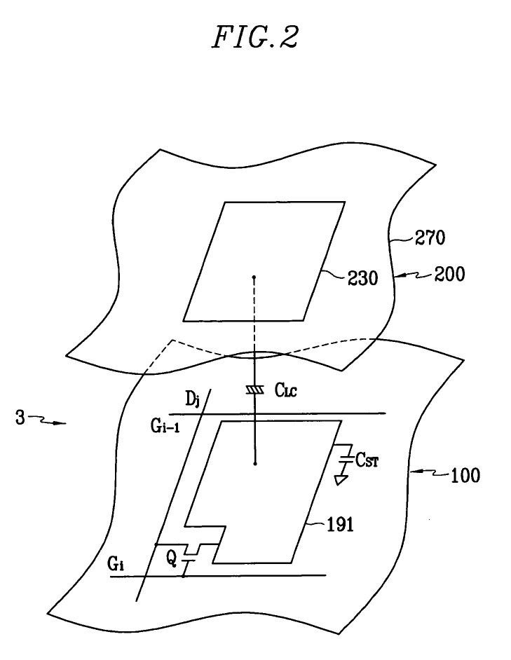

Now, an exemplary liquid crystal display apparatus according to an exemplary embodiment of the present invention will be described in detail with reference to FIGS. 1 and 2.

FIG. 1 is a block diagram showing an exemplary liquid crystal display apparatus according to an exemplary embodiment of the present invention. FIG. 2 is an equivalent circuit schematic diagram showing an exemplary pixel of the liquid crystal display apparatus according to an exemplary embodiment of the present invention.

As shown in FIG. 1, an exemplary liquid crystal display apparatus according to the exemplary embodiment of the present invention includes a liquid crystal panel assembly 300, a gate driver 400 and a data driver 500 connected to the liquid crystal panel assembly 300, a gray voltage generator 800 connected to the data driver 500, and a signal controller 600 for controlling the components.

As seen in the equivalent circuit schematic diagram, the liquid crystal panel assembly 300 includes a plurality of signal lines G₁ to Gₙ and D₁, to Dₘ, and a plurality of pixels PX that are arrayed substantially in a matrix and connected to the plurality of signal lines G₁ to Gₙ and D₁ to Dₘ. As shown in FIG. 2, the liquid crystal panel assembly 300 includes lower and upper panels 100 and 200, respectively, facing each other and a liquid crystal layer 3 interposed therebetween.

The signal lines G₁ to Gₙ and D₁ to Dₘ include a plurality of gate lines G₁ to Gₙ for transmitting gate signals (sometimes referred to as “scan signals”), and a plurality of data lines D₁ to Dₘ for transmitting data signals. The gate lines G₁ to Gₙ extend in parallel to each other substantially in a row direction, and the data lines D₁ to Dₘ extend in parallel to each other substantially in a column direction.

Each of the pixels PX, for example a pixel PX connected to an i-th gate line Gᵢ (e.g., i=1, 2, . . . , n) and a j-th data line Dj (e.g., j=1, 2, . . . , m), includes a switching device Q connected to the signal lines Gᵢ and Dⱼ, a liquid crystal capacitor C_{LC} connected thereto and a storage capacitor C_{ST}. The storage capacitor C_{ST} may be omitted as needed.

The switching device Q is a three-port device, such as a thin film transistor (“TFT”), and is disposed in the lower panel 100. The switching device Q as a three-port device has a control port connected to the gate line G₁, an input port connected to the data line Dⱼ, and an output port connected to the liquid crystal capacitor C_{LC} and the storage capacitor C_{ST}.

Two ports of the liquid crystal capacitor C_{LC} are a pixel electrode 191 of the lower panel 100 and a common electrode 270 of the upper panel 200, and the liquid crystal layer 3 interposed between the two electrodes 191 and 270 serves as a dielectric member. The pixel electrode 191 is connected to the switching device Q, and the common electrode 270 is disposed at the upper panel 200 to receive a common voltage V_{com}. Unlike as shown in FIG. 2, the common electrode 270 may be disposed at the lower panel 100, and in this case, at least one of the two electrodes 191 and 270 may be formed in a shape of a line or a bar.

The storage capacitor C_{ST} has an auxiliary function for the liquid crystal capacitor C_{LC} and is constructed by overlapping a separate signal line (not shown) and the pixel electrode 191 provided at the lower panel 100 with an insulating member interposed therebetween. A predetermined voltage such as the common voltage V_{com} is applied to the separate signal line. However, alternatively, the storage capacitor C_{ST} may be constructed by overlapping the pixel electrode 191 with a gate line disposed thereabove with an insulating member interposed therebetween.

In order to implement color display, each of the pixels uniquely displays one of three colors (spatial division), or each of the pixels alternately displays the three colors according to time (time division). A desired color can be obtained by a spatial or time combination of the three colors. Examples of the three colors include, red, green and blue, for example, and may include primary colors. FIG. 2 shows an example of the spatial division. As shown in the figure, each of the pixels PX includes a color filter 230 for representing one of the three colors, which is provided at a region of the upper panel 200 corresponding to the pixel electrode 191. Unlike as shown in FIG. 2, the color filter 230 may be provided above or below the pixel electrode 191 of the lower panel 100.

At least one polarizer (not shown) for polarizing light is provided on outer surfaces of the liquid crystal display panel assembly 300.

Returning to FIG. 1, the gray voltage generator 800 generates two gray voltage sets (reference gray voltage sets) corresponding to a transmittance of each of the pixels PX. The one gray set has a positive value with respect to the common voltage V_{com}, and the other gray voltage set has a negative value with respect to the common voltage V_{com}.

The gate driver 400 is connected to the gate lines G₁ to Gₙ of the liquid crystal panel assembly 300 to apply gate signals constructed with a combination of gate-on and gate-off voltages Vₒₙ and V_{off}, respectively, to the gate lines G₁ to Gₙ.

The data driver 500 is connected to the data lines D₁ to Dₘ of the liquid crystal panel assembly 300 to select the gray voltage from the gray voltage generator 800 and apply the gray voltages as data signals to the data lines D₁ to Dₘ. Alternatively, in a case where the gray voltage generator 800 generates only a predetermined number of reference gray voltages instead of all of the gray voltages, the data driver 500 may generate the gray voltages for all of the grays by dividing the reference gray voltages and selecting the data signals from among the generated gray voltages.

The signal controller 600 controls the gate driver 400, the data driver 500, and the like.

The drivers 400, 500 and 800 and controller 600 may be directly mounted in a form of at least one IC chip on the liquid crystal panel assembly 300. Alternatively, the drivers 400, 500 and 800 and controller 600 may be attached in a form of a tape carrier package (“TCP”) on a flexible printed circuit (“FPC”) film (not shown) in the liquid crystal panel assembly 300. As a further alternative, the drivers 400, 500 and 800 and controller 600 together with the signal lines G₁ to Gₙ and D₁, to Dₘ and the thin film transistor switching devices Q may be integrated with the liquid crystal panel assembly 300. In addition, the drivers 400, 500 and 800 and controller 600 may be integrated in a single chip. In this case, at least one thereof or at least one circuit device thereof may be disposed outside the single chip.

Now, a display operation of the liquid crystal display apparatus will be described in detail.

The signal controller 600 receives input image signals R, G and B and input control signals for controlling display thereof from an external graphics controller (not shown). An example of the input control signals includes a vertical synchronization signal Vsync, a horizontal synchronization signal Hsync, a main clock signal MCLK and a data enable signal DE.

The signal controller 600 processes the input image signals R, G and B according to an operating condition of the liquid display panel assembly 300 based on the input control signals and the input image signals R, G and B to generate a gate control signal CONT1, a data control signal CONT2, and the like, and then transmits the generated gate control signal CONT1 to the gate driver 400 and the generated data control signal CONT2 and the processed image signal DAT2 to the data driver 500.

The gate control signal CONT1 includes a scan start signal STV for indicating scan start and at least one clock signal for controlling an output period of the gate-on voltage Vₒₙ. The gate control signal CONT1 may further include an output enable signal OE for defining a duration time of the gate-on voltage Vₒₙ.

The data control signal CONT2 includes a horizontal synchronization start signal STH for indicating data transmission for one pixel row, a load signal LOAD for commanding to apply the associated data voltages to the data lines D₁ to Dₘ, and a data clock signal HCLK. The data control signal CONT2 may further include an inversion control signal RVS for inverting a voltage polarity of the data signal with respect to the common voltage V_{com} (hereinafter, “the voltage polarity of the data signal with respect to the common voltage V_{com}” is abbreviated to a “data signal polarity”). In response to the data control signal CONT2 from the signal controller 600, the data driver 500 receives the digital image data DAT2 for one pixel row and selects the gray voltages corresponding to the digital image data DAT2, so that the digital image data DAT2 are converted into the associated analog data signals. After that, the analog data signals are applied to the associated data lines D₁, to Dₘ.

The gate driver 400 applies the gate-on voltage Vₒₙ to the gate lines G₁ to Gₙ according to the gate control signals CONT1 from the signal controller 600 to turn on the switching devices Q connected to the gate lines G₁ to Gₙ. As a result, the data signals applied to the data lines D₁ to Dₘ are applied to the associated pixels PX through the turned-on switching devices Q.

A difference between the voltage of the data signal applied to the pixel PX and the common voltage V_{com} becomes a charge voltage of the liquid crystal capacitors C_{LC}, that is, a pixel voltage. Alignment of the liquid crystal molecules in the liquid crystal layer 3 varies according to the intensity of the pixel voltage. Therefore, polarization of light passing through the liquid crystal layer 3 changes. The change in the polarization results in a change in transmittance of the light due to the polarizer (not shown) attached to the liquid crystal panel assembly 300.

In units of one horizontal period (or 1H), that is, one period of the horizontal synchronization signal Hsync and the data enable signal DE, the aforementioned operations are repetitively performed to sequentially apply the gate-on voltages Vₒₙ to all of the gate lines G₁ to Gₙ, so that the data signals are applied to all the pixels. As a result, one frame of an image is displayed.

When one frame ends, the next frame starts, and a state of the inversion control signal RVS applied to the data driver 500 is controlled so that the polarity of the data signal applied to each of the pixels is opposite to the polarity in the previous frame (frame inversion). At this time, even in one frame, according to the characteristics of the inversion control signals RVS, the polarity of the data signal flowing through the one data line may be inverted (row inversion and dot inversion). In addition, the polarities of the data signals applied to the one pixel row may be different from each other (column inversion and dot inversion).

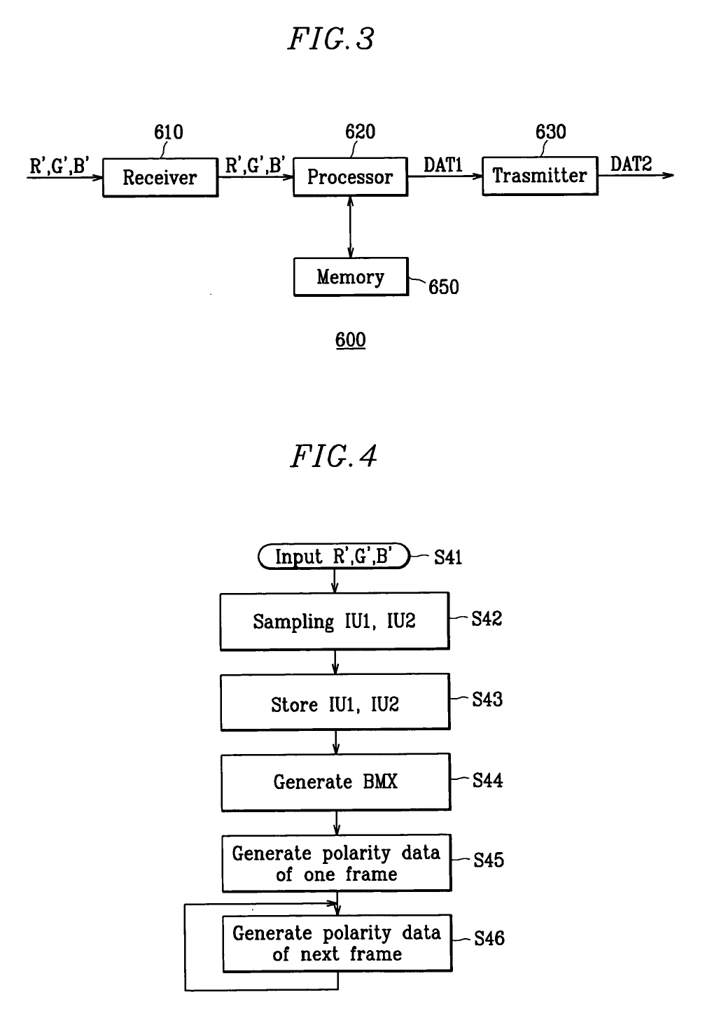

Now, an exemplary liquid crystal display apparatus according to an exemplary embodiment of the present invention will be described with reference to FIGS. 3 to 9.

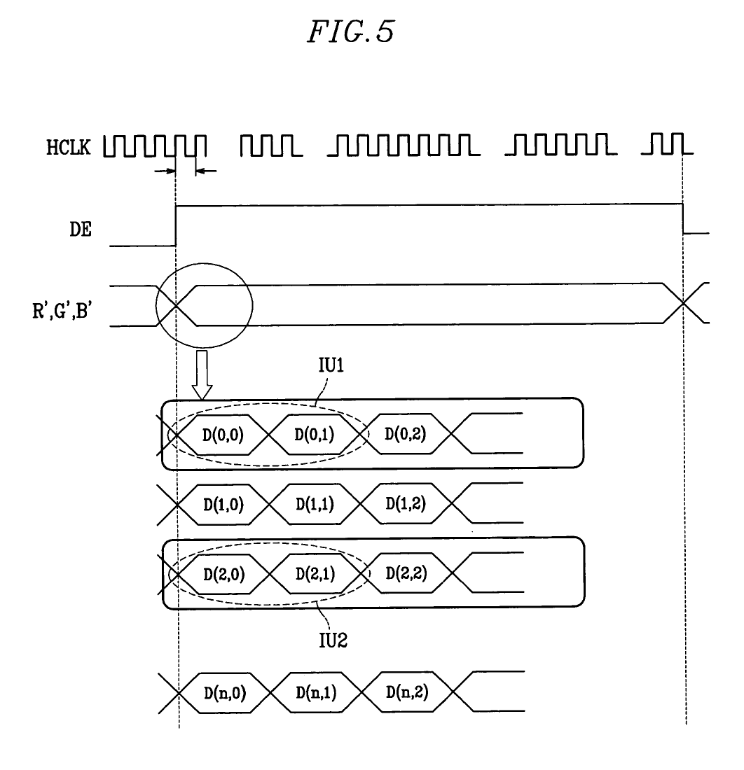

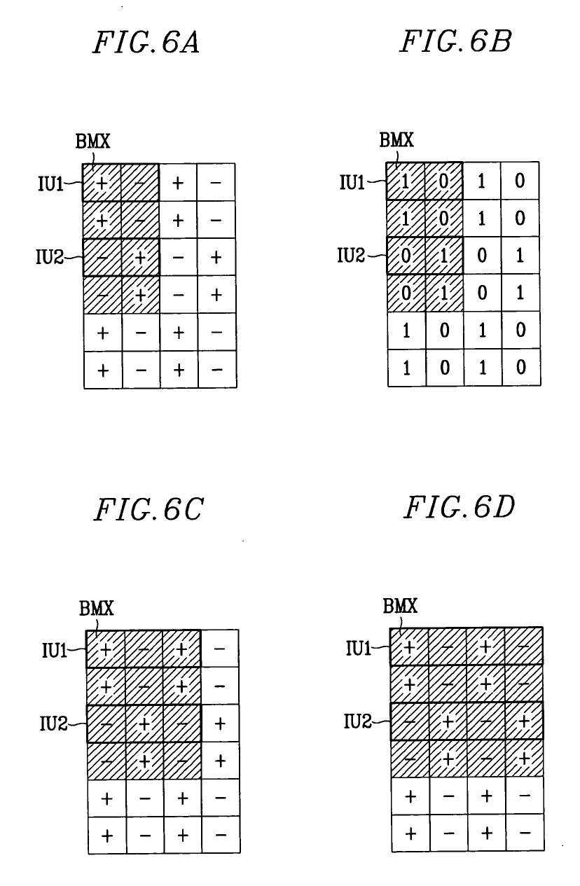

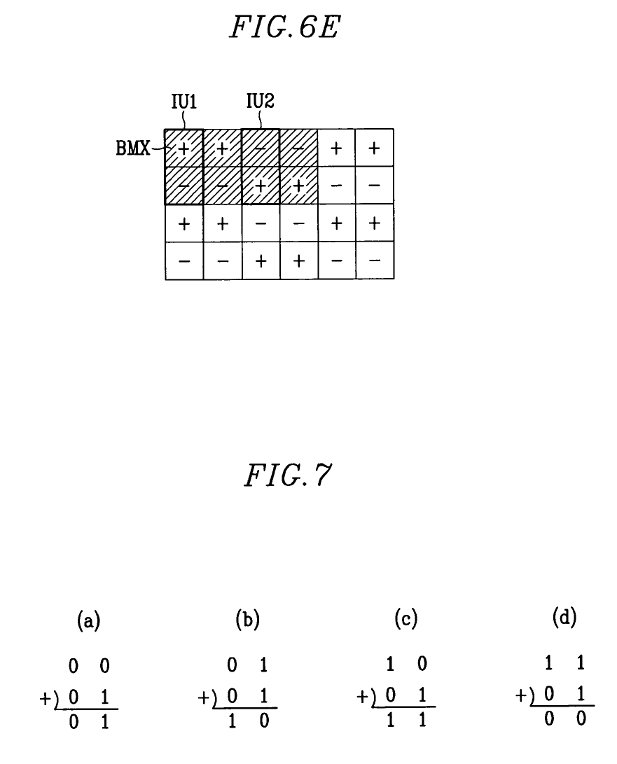

FIG. 3 is a schematic block diagram showing a signal controller shown in FIG. 1, and FIG. 4 is a flowchart showing an exemplary method of driving a liquid crystal display apparatus according to an exemplary embodiment of the present invention. FIG. 5 is shows a sampling of an exemplary method of driving a liquid crystal display apparatus according to an exemplary embodiment of the present invention. FIGS. 6A and 6B are tables showing inversion units and corresponding signs in an exemplary inversion driving scheme according to an exemplary embodiment of the present invention. Hereinafter, polarities of voltages of pixels in odd-numbered and even-numbered pixel rows are referred to as odd-numbered and even-numbered row polarities, respectively. Referring to FIG. 3, a signal controller 600 includes a receiver 610, a processor 620 connected to the receiver 610, a memory 650 connected to the processor 620, and a transmitter 630 connected to the processor 620.

The receiver 610 receives input image signals R, G and B that are transmitted in a low voltage differential signaling (LVDS) scheme from a graphics controller (not shown), and transmits image signals R′, G′ and B′ in a transistor-transistor logic (“TTL”) scheme to the processor 620.

The processor 620 performs sampling of the image signals R′, G′ and B′ transmitted in the TTL scheme, and data processing thereof. The processor 620 transmits processed data DAT1 to the transmitter 630. The transmitter 630 receives the processed data DAT1 and transmits an image signal DAT2 in a reduced swing differential signaling (“RSDS”) scheme to the data driver 500.

Operations of the processor 620 will now be described.

Firstly, when the image signals R′, G′ and B′ are input (S41), the processor 620 performs sampling of first and second inversion units IU1 and IU2 (S42).

In FIG. 5, the image signals R′, G′ and B′ corresponding to one frame are shown, and an enlarged view of a portion thereof is shown in a lower portion of the figure indicated by the arrow thereof. Here, D(x,y) denotes a data value of a pixel located at an (x+1)-th row and a (y+1)-th column. For example, D(0,0) denotes a data value of a pixel located at the first row and the first column.

As shown in FIG. 5, the sampling of the inversion units IU1 and IU2 is performed by selecting the data values D(0,0) and D(0,1) of two pixels located at the first and second columns of the first row as the first inversion unit IU1, and subsequently selecting the data values D(2,0) and D(2,1) of two pixels located at the first and second columns of the third row as the first inversion unit IU2. Here, the sampling of the inversion units IU1 and IU2 is the sampling of the polarities of the data thereof.

Next, the sampled inversion units IU1 and IU2 are stored in the memory 650 (S43), and a basic matrix BMX is generated by using the inversion units IU1 and IU2 (S44). Next, polarity data of the one frame are generated by using the basic matrix BMX (S45). These processes will be described hereinafter.

The inversion driving scheme according to the exemplary embodiment of the present invention is basically a two-dot inversion driving scheme. In addition, as shown in FIG. 6, adjacent odd-numbered and even-numbered rows have the same polarity. For example, the adjacent first and second rows of the first column have the same positive polarity (+), and the adjacent first and second rows of the second column have the same negative polarity (−). The polarity array alternately repeats in the row direction. Similarly, for example, the adjacent third and fourth rows of the first column have the same negative polarity (−), and the adjacent third and fourth rows of the second column have the same positive polarity (+). The polarity array alternately repeats in the row direction.

Therefore, as shown in FIG. 6A, the inversion units IU1 and IU2 alternately repeat in units of two rows in the column direction. With respect to the first inversion unit IU1, since the adjacent odd-numbered and even-numbered rows in the same column have the same polarity, the two first inversion units IU1 repeat in units of four rows in the column direction. Therefore, in the same column, the first and second rows, the fifth and sixth rows, and the ninth and tenth rows, respectively, and the like have the same polarity. Namely, IU1=4K+1, 4K+2 (where K=0, 1, 2, 3, . . . )

With respect to the second inversion unit IU2, the two second inversion units IU2 also repeat in units of four rows in the column direction. Therefore, in the same column, the third and fourth rows, the seventh and eighth rows, and the eleventh and twelfth rows, respectively, and the like have the same polarity. IU 2=4(K+1)−1, 4(K+1) (K=0, 1, 2, 3, . . . )

Next, as shown in FIG. 6A, a matrix including two first inversion units IU1 adjacent to each other in the column direction and two second inversion units IU2 adjacent to each other in the column direction is defined as a basic matrix BMX (S44). Next, by expanding the basic matrix BMX, an inversion pattern for one frame is obtained (S45).

The inversion units IU1 and IU2 may include polarity data for three pixels or more, as well as for two pixels as described above. For example, as shown in FIGS. 6C and 6D, the number of pixels constituting the inversion units IU1 and IU2 may be three, four or more. The inversion units IU1 and IU2 may be a 1×2 matrix that repeats in the row direction shown in FIG. 6A. Alternatively, the inversion units IU1 and IU2 may be a 2×1 matrix that repeats in the column direction as shown in FIG. 6E. In this case, the 2×1 matrix is a transposed matrix of the 1×2 matrix, and the basic matrix BMX is a 2×4 matrix. For convenience of description, a case where the inversion units IU1 and IU2 and the basic matrix BMX are 1×2 and 4×2 matrixes will be described. The processor 620 then generates polarity data for the next frame (S46). The process thereof will now be described.

Since the polarities of the pixel voltages are two types, that is, the positive and negative polarities (+) and (−), the polarities can be represented with binary numbers. For example, as shown in FIG. 6B, the positive (+) and negative (−) polarities are denoted by 1 and 0, respectively.

Therefore, in FIG. 6B, the inversion units IU1 and IU2 are represented by “10” and “01”, respectively. By adding a binary number “01” to the binary numbers “10” and “01” of the inversion units IU1 and IU2, for example, the binary numbers “11” and “10” can be obtained as shown in (a) to (d) of FIG. 7.

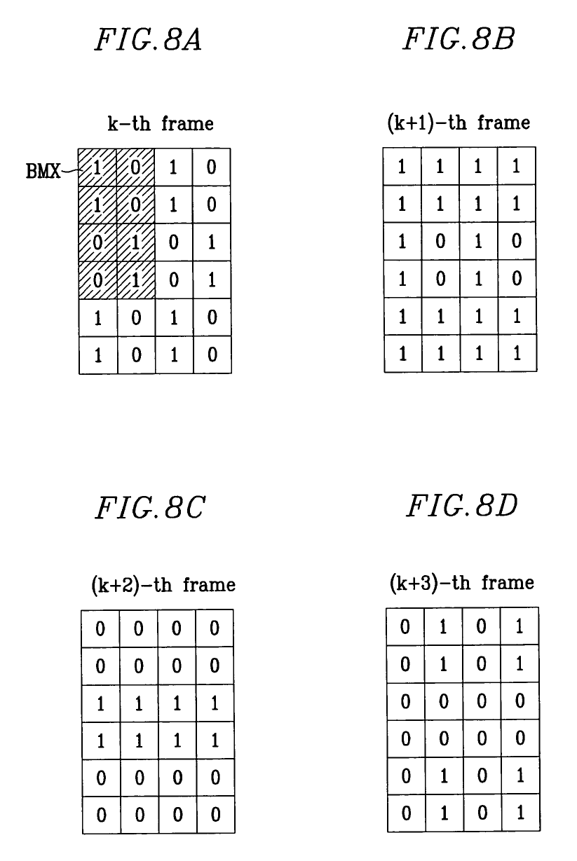

In the inversion driving scheme according to the exemplary embodiment of the present invention, the binary polarity pattern of the next frame is obtained by adding the binary number “01” to the binary polarity data for the current frame. The process will be described in detail with reference to FIGS. 8A to 8D.

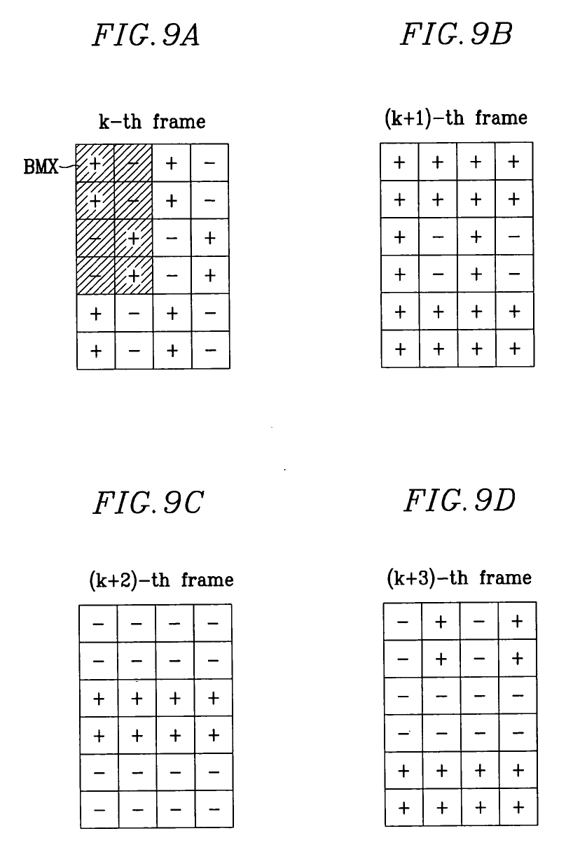

FIG. 8A shows a binary polarity pattern for an arbitrary k-th frame. In the binary polarity pattern shown in FIG. 8A, the first and second inversion units IU1 and IU2 are represented by “10” and “01”, respectively. By adding the binary number “01” to the binary numbers “10” and “01” for the first and second inversion units IU1 and IU2, binary numbers “11” and “10” are obtained as shown in FIGS. 7C and 7B, respectively. The binary numbers “11” and “10” are new inversion units for the (k+1)-th frame. By expanding the new inversion units, the binary polarity pattern for the (k+1)-th frame shown in FIG. 8B is obtained. Similarly, by adding the binary number “01” to the binary numbers “11” and “10” for the first and second inversion units IU1 and IU2, respectively, in the binary polarity pattern shown in FIG. 8B, binary numbers “00” and “11” are obtained as shown in FIGS. 7D and 7C, respectively. The binary numbers “00” and “11” are new inversion units for the (k+2)-th frame. By expanding the new inversion units, the binary polarity pattern for the (k+2)-th frame shown in FIG. 8C is obtained. Next, by repeating the same process, the binary polarity pattern for the (k+3)-th frames shown in FIG. 8D can be obtained. Finally, by repeating the same process, the binary polarity pattern for the k-th frames shown in FIG. 8A can be obtained. As a result, the same polarity pattern repeats in units of four frames. FIGS. 9A to 9D show sign polarity patterns corresponding to the binary polarity pattern of the polarity data of FIGS. 8A to 8D.

In summary, the signal controller 600 stores the inversion units IU1 and IU2 for the first frame in the memory 650, and expands the inversion units IU1 and IU2 by a predetermined rule to generate the polarity data of the first frame. Next, the signal controller 600 reads out the inversion units IU1 and IU2 from the memory 650 and generates new inversion units IU1 and IU2. Next, the signal controller 600 expands the new inversion units IU1 and IU2 to generate the polarity data of the next frame and stores the new inversion units IU1 and IU2 in the memory 650. The same process is performed on the next frame.

The signal controller 600 performs polarity inversion by using the above-described inversion control signal RVS.

In this manner, polarities of the pairs of pixels corresponding to the inversion units IU1 and IU2 are sequentially inverted, so that arbitrary polarity inversion can be individually performed on the pixels. Therefore, it is possible to prevent the cross line defect that is caused by variation in charging voltages in a conventional two-dot inversion driving scheme that is performed in units of two adjacent pixel rows. In addition, positive and negative polarity data voltages are applied to the frames in units of one frame in a specific pattern such as a two-dot pattern, so that it is possible to reduce flicker. For example, as shown in FIGS. 9A to 9D, the polarity of the odd-numbered columns of the first row is inverted in units of two frames, and the polarity of the even-numbered columns of the first row is inverted in units of one frame. Therefore, the number of pixels of which polarities are inverted in units of one frame can be reduced by half, so that it is possible to reduce flicker by as much as the reduced number. In the case of a two-dot pattern, all the pixels are not provided with a white gray voltage corresponding to the highest gray, but a portion of pixels are provided with the white gray voltage, so that it is possible to further reduce the flicker.

As described above, arbitrary inversion is performed individually on the pixels and then polarity inversion is performed in units of four frames, so that it is possible to prevent or reduce the cross line defects and the flicker.

Although exemplary embodiments and modified examples of the present invention have been described, the present invention is not limited to the exemplary embodiments and examples, but may be modified in various forms without departing from the scope of the appended claims, the detailed description, and the accompanying drawings of the present invention. Therefore, it is natural that such modifications belong to the scope of the present invention.

What is claimed is:

1. An apparatus for driving a liquid crystal display apparatus having a plurality of pixels arrayed in a matrix, the apparatus comprising:
a receiver for receiving input image data;
a data processor for processing output image data output from the receiver; and
a memory and a transmitter connected to the data processor,
wherein the data processor selects a portion of polarities from the output image data and generates a plurality of polarities of the same number as the portion of the polarities to generate polarity data for one frame.

2. The apparatus of claim 1, wherein the data processor generates a basic matrix based on first and second inversion units including at least one pixel, and generates a plurality of matrixes equal to the basic matrix to generate the polarity of the one frame.

3. The apparatus of claim 2, wherein the data processor selects polarity data for first and second pixel groups as the first and second inversion units, and wherein each of the first and second pixel groups includes at least two pixels that are adjacent to each other in a row or column direction.

4. The apparatus of claim 3, wherein the basic matrix is generated by repeating the first and second inversion units in the row or column direction at least once.

5. The apparatus of claim 4, wherein the first and second pixel groups are located in the first and second rows or in the first and second columns.

6. The apparatus of claim 5, wherein the first and second inversion units are located in one row interval or in one column interval.

7. The apparatus of claim 6, wherein the memory stores the first and second inversion units or the basic matrix.

8. The apparatus of claim 7,
wherein the basic matrix is an N×M or an M×N matrix, and
wherein N is a natural number of 4 or more and M is a natural number of 2 or more.

9. The apparatus of claim 8, wherein the data processor generates the polarity data of a next frame for the first and second inversion units based on the polarity data of a current frame for the first and second inversion units.

10. The apparatus of claim 9, wherein the polarity data of the next frame is a bit value obtained by adding 1 to the polarity data of the current frame.

11. The apparatus of claim 10, wherein the polarities of the first and second inversion units repeat in units of at least four frames.

12. The apparatus of claim 2, wherein the data processor generates the polarity data of a next frame for the first and second inversion units based on the polarity data of a current frame for the first and second inversion units.

13. The apparatus of claim 12, wherein the polarity data of the next frame is a bit value obtained by adding 1 to the polarity data of the current frame.

14. The apparatus of claim 13, wherein the polarities of the first and second inversion units repeat in units of at least four frames.

15. The apparatus of claim 1, wherein the receiver outputs the input image data that is input in a low voltage differential signaling (LVDS) scheme to the data processor in a transistor-transistor logic (TTL) scheme.

16. The apparatus of claim 15, further comprising a data driver for applying data voltages to the pixels,
wherein the transmitter outputs the output image data that is output from the data processor to the data driver in a reduced swing differential signaling (RSDS) scheme.

17. A method of driving a liquid crystal display apparatus having a plurality of pixels arrayed in matrix, the method comprising:
selecting first and second inversion units;
storing the first and second inversion units;
generating a basic matrix based on the first and second inversion units; and
generating polarity data for the pixels by expanding the matrix.

18. The method of claim 17, wherein the selecting the first and second inversion units comprises selecting the polarity data for first and second pixel groups, each of which includes at least two pixels that are adjacent to each other in a row or column direction.

19. The method of claim 18, wherein the first and second pixel groups are located in one row interval or in one column interval.

20. The method of claim 19, wherein the generating the basic matrix comprises repeating the first and second pixel groups in the row or column direction.

21. The method of claim 20,
wherein the basic matrix is an N×M or an M×N matrix, and
wherein N is a natural number of 4 or more and M is a natural number of 2 or more.

22. The method of claim 21, further comprising generating polarity data for a next frame based on the polarity data of a current frame for the pixels.

23. The method of claim 22, wherein the generating the polarity data for the next frame comprises:
generating a basic matrix by sequentially changing polarities of the first and second inversion units; and
generating a plurality of matrixes that are equal to the basic matrix to generate the polarity data of the next frame.

24. The method of claim 22, wherein the first and second inversion units repeat in units of at least four frames.
